(19) United States
(12) Patent Application Publication
(10) Pub. No.: US 2026/0250932 A1
(43) Pub. Date: Aug. 27, 2026

(54) CONTROL SYSTEM AND CONTROL METHOD

(71) Applicant: KOMATSU LTD., Tokyo (JP)

(72) Inventors: Yosuke YAMAGUCHI, Tokyo (JP); Satoru SHINTANI; Naoki HIEDA, Tokyo (JP); Akihide NAMURA, Tokyo (JP); Toshiaki TANAKA, Tokyo (JP); Takashi KURIHARA, Tokyo (JP)

(21) Appl. No.: 18/861,707

(22) PCT Filed: Jun. 7, 2023
(86) PCT No.: PCT/JP2023/021087

§ 371 Date: Oct. 30, 2024

(30) Foreign Application Priority Data
Jun. 9, 2022 (JP) 2022-093968

(51) Int. Cl. E02F 9/20; G06Q 50/18

(52) U.S. Cl. CPC E02F 9/2025; G06Q 50/18

(57) ABSTRACT

A control system determines whether there is a right to use a machine control function of a drive mechanism provided in a work machine. The control system includes a drive controller to control the drive mechanism, and an acquisition unit to acquire contract information relating to the use of the machine control function. The drive controller determines whether there is the right to use the machine control function based on the contract information.

### CROSS-REFERENCE TO RELATED APPLICATIONS

This application is a U.S. National stage application of International Application No. PCT/JP 2023/021087, filed on Jun. 7, 2023. This U.S. National stage application claims priority under 35 U.S.C. § 119(a) to Japanese Patent Application No. 2022-093968, filed in Japan on Jun. 9, 2022, the entire contents of which are hereby incorporated herein by reference.

### BACKGROUND

### Technical Field

The present invention relates to a control system and a control method for a work machine.

### Background Information

Recently, information and communication technology (ICT) construction that uses a work machine having a machine control function (referred to below as “MC function”) is becoming more widespread (for example, see International Publication No. 2016/148311).

A hydraulic excavator, a bulldozer, a wheel loader, a motor grader, and a dump truck are examples of work machines. The MC function is a function for automatically controlling or semi-automatically controlling the drive mechanism of the work machine. The drive mechanism of the work machine may include a work implement, a rotating mechanism, and a travel device. Examples of MC functions include automatic work implement stop control, automatic leveling assist control, rotation alignment control, travel alignment control, and autonomous driving control.

### SUMMARY

Since the development of MC functions involves various costs, the development costs for MC functions have been passed along thus increasing the price of work machines because the MC functions have been set so as to be useable without limitations in conventional work machines. A work machine provided with an MC function carries additional electronic devices for realizing the MC function and thus the price of such a work machine is higher than a work machine not provided with the MC function. Therefore, the size of the initial investment costs when introducing a work machine having an MC function is one factor that hinders the spread of ICT construction.

A work machine provided with an MC function may also be leased or rented by a user. In this case, the user may still have to pay for a high rental fee or leasing fee regardless of whether the user only uses a portion of the MC function when using the work machine, or whether the user does not use the MC function during the entirety of the rental period or the leasing period.

Additionally, there may be a desire to allow the user who uses the work machine provided with the MC function to use all or a portion of the functions of the MC function by using a simple system.

An object of the present disclosure is to provide a control system and a control method with which a user may easily introduce a work machine having an MC function.

A control system according to an embodiment of the present disclosure determines whether there is a right to use a machine control function of a drive mechanism provided in a work machine. The control system comprises a drive controller configured to control the drive mechanism and an acquisition unit configured to acquire contract information relating to the usage of the machine control function. The drive controller is configured to determine whether there is the right to use the machine control function based on the contract information.

According to the present disclosure, it is possible to provide a control system and a control method with a work machine having an MC function may be easily introduced.

### BRIEF DESCRIPTION OF DRAWINGS

FIG. 1 is a side view of a hydraulic excavator according to an embodiment.

FIG. 2 is a block diagram of a control system according to the embodiment.

FIG. 3 is a flow chart for explaining a control for switching an MC function to enabled or disabled.

FIG. 4 is a flow chart for explaining a control for calculating a charging amount for the use of the MC function.

FIG. 5 is a block diagram of a control system according to modified example 9.

### DETAILED DESCRIPTION OF EMBODIMENT(S)

### (Work Machine)

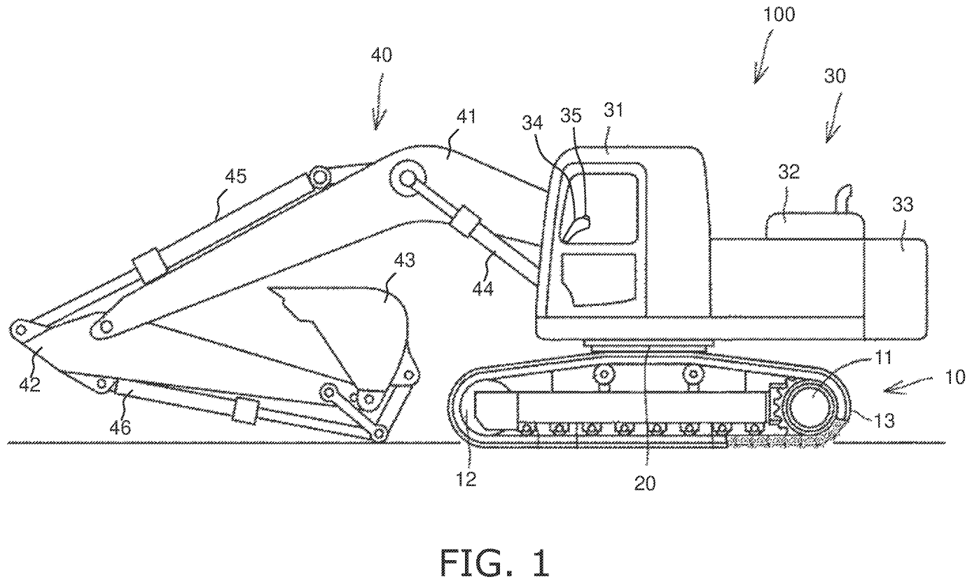

A configuration of a hydraulic excavator 100 that is an example of a work machine will be explained with reference to the drawings. FIG. 1 is a side view of a hydraulic excavator 100 according to the present embodiment.

The hydraulic excavator 100 has a belowmentioned machine control function (referred to below as “MC function”) for a drive mechanism and is a work machine that is applicable to ICT construction. The MC function of the drive mechanism is a function for automatically controlling or semi-automatically controlling the drive mechanism of the work machine. The drive mechanism of the work machine may include a work implement, a rotating mechanism, and a travel device. In the case of the hydraulic excavator 100 indicated in the present embodiment, examples of MC functions that are machine control functions include all of or a portion of automatic work implement stop control, automatic leveling assist control, rotation alignment control, travel alignment control, and autonomous driving control.

As illustrated in FIG. 1, the hydraulic excavator 100 comprises a travel device 10, a rotation device 20, a rotating body 30, and a work implement 40. The travel device 10, the rotation device 20, and the work implement 40 are each examples of a “drive mechanism” according to the present disclosure. In the following explanation, the travel device 10, the rotation device 20, and the work implement 40 may be collectively referred to as the “drive mechanism.” The travel device 10 includes drive wheels 11, idler wheels 12, and crawler belts 13. The crawler belts 13 are wound onto the drive wheels 11 and the idler wheels 12. The hydraulic excavator 100 travels due to the drive wheels 11 being driven by driving power from the engine.

The rotation device 20 is disposed between the travel device 10 and the rotating body 30. The rotation device 20 causes the rotating body 30 to rotate with respect to the travel device 10 about an axis in the up-down direction. The rotating body 3 has cab 31, an engine room 32, and a counterweight 33. A drive member 34 for operating the drive mechanism is disposed inside the cab 31. An auto/manual switch (referred to below as “A/M switch”) 35 that receives lock and unlock operations of the MC function is attached to the drive member 34.

In the present embodiment, the A/M switch 35 receives the lock and unlock operations from the user of the hydraulic excavator 100. The user may be the person who actually operates the hydraulic excavator 100, the person who manages the purchased hydraulic excavator 100, or both.

The A/M switch 35 receives the unlock operation when pressed by the user and receives the lock operation when pressed again by the user. The A/M switch 35 is an example of an “operating unit” according to the present disclosure. The engine room 32 accommodates the engine and a hydraulic pump and the like. Unlocking the MC function signifies enabling the MC function and locking the MC function signifies disabling the MC function.

The work implement 40 is used for various types of work such as excavation or leveling. The work implement 40 includes a boom 41, an arm 42, a bucket 43, and hydraulic cylinders 44-46. The base end of the boom 41 is coupled to the rotating body 30 in a rotatable manner. The base end of the arm 42 is coupled to the distal end of the boom 41 in a rotatable manner. The bucket 43 is coupled to the distal end of the arm 42 in a rotatable manner. The hydraulic cylinders 44-46 respectively drive the boom 41, the arm 42, and the bucket 43.

### (Control System)

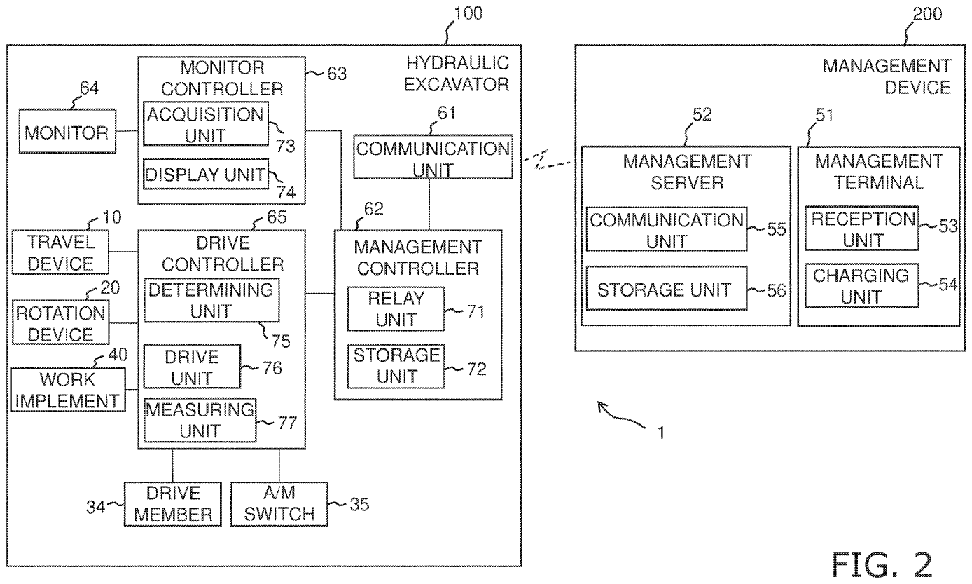

Hereinbelow, a configuration of a control system 1 according to the present embodiment will be explained with reference to the drawings. FIG. 2 is a block diagram of the control system 1 according to the embodiment.

The control system 1 switches the MC function in the hydraulic excavator 100 between enabled and disabled. The control system 1 comprises the hydraulic excavator 100 and a management device 200.

### (Management Device 200)

The management device 200 is a device for managing the hydraulic excavator 100. The management device 200 includes a management terminal 51 and a management server 52.

The management terminal 51 is a terminal used by the seller of the hydraulic excavator 100 or the administrator of the management device 200. For example, a personal computer, a tablet terminal, or a smartphone can be used as the management terminal 51. A management application for managing the hydraulic excavator 100 is installed in the management terminal 51.

The management terminal 51 includes a reception unit 53 and a charging unit 54.

In the present embodiment, a case in which the person who is the user of the hydraulic excavator 100 purchases the hydraulic excavator 100 will be explained. The reception unit 53 receives the input of contract information relating to the use of the MC function agreed to between the seller and the user of the hydraulic excavator 100. A usage pattern that indicates usage forms of the MC function is included in the contract information. The contract information includes one usage pattern among a plurality of usage patterns. The plurality of usage patterns include at least a usage pattern that requires charging for the use of the MC function and a usage pattern that does not require charging for the use of the MC function. There are a plurality of MC functions that can be realized by the hydraulic excavator 100 and the contract information may be set based on allowing the use of only a portion of the plurality of MC functions and not allowing the use of the other MC functions. Specifically, the contract information may be based on a selection from the plurality of MC functions in accordance with the needs of the user.

Three usage patterns are assumed in the present embodiment including a usage pattern A, a usage pattern B, and a usage pattern C among the plurality of usage patterns. The usage pattern A indicates that the MC functions of the drive mechanism provided to the hydraulic excavator 100 can always be used freely without restriction. That is, there is no charge for the additional use of the MC functions of the drive mechanism provided to the hydraulic excavator 100 in the usage pattern A. The usage pattern B indicates that there is a charge for using the MC functions. Usage pattern C indicates that the MC functions cannot be used in any way.

Therefore, the usage pattern A and the usage pattern B indicate that the user of the hydraulic excavator 100 has a right to use the MC functions and the usage pattern C indicates that the user of the hydraulic excavator 100 does not have the right to use the MC functions.

The usage pattern included in the contract information is determined based on an agreement between the seller and the user. The reception unit 53 transmits the inputted contract information to a belowmentioned communication unit 55 of the management server 52. The reception unit 53 also transmits modified contract information to the communication unit 55 of the management server 52 when the contract information is modified.

The charging unit 54 acquires an unlock time period of the MC function from a belowmentioned storage unit 56 in the management server 52. The charging unit 54 calculates the charging amount for the use of the MC function based on the unlock time period of the MC function. The method for calculating the charging amount is not limited and may include, for example, a method that involves multiplying the unlock time period (minutes) by one unit of a usage amount, or a method that involves multiplying the number of days in which the unlock time period is equal to or greater than a predetermined time period by one unit of the usage amount. While the unlock time period of the MC function is explained below, the unlock time period of the MC function is measured when the usage pattern included in the contract information is the usage pattern B. Therefore, when the usage pattern included in the contract information is the usage pattern A or the usage pattern C, the charging unit 54 does not calculate the charging amount for the user of the MC function. However, the time period or the number of days that the MC function is used may also be measured for the usage pattern A.

The management server 52 may be a physical server or may be a virtual server. The management server 52 includes the communication unit 55 and the storage unit 56. The hardware that includes the functions of the management server 52 is mounted on the hydraulic excavator 100 and the vehicle-mounted hardware may be able to communicate with a communication unit provided to the management device 200 wirelessly or over a communication network such as the Internet.

The communication unit 55 is able to communicate with the hydraulic excavator 100 and the management terminal 51 over a communication network. When the communication unit 55 receives the contract information (including at least one of the usage pattern A, usage pattern, B, and usage pattern C) from the reception unit 53 of the management terminal 51, the received contract information is stored in the storage unit 56. When the contract information is requested from a belowmentioned monitor controller 63, the contract information stored in the storage unit 56 is received by a communication unit 61 over the communication network and transmitted to the monitor controller 63 via a management controller 62.

When the communication unit 55 receives the unlock time period from a belowmentioned drive controller 65, the received unlock time period is stored in the storage unit 56. When the communication unit 55 requests the unlock time period from the charging unit 54 of the management terminal 51, the unlock time period stored in the storage unit 56 is transmitted to the charging unit 54.

The storage unit 56 stores the contract information and the unlock time period. The storage unit 56 may be a physical storage device or may be a virtual storage device.

### (Hydraulic Excavator 100)

The hydraulic excavator 100 includes the communication unit 61, the management controller 62, the monitor controller 63, a monitor 64, and the drive controller 65. The hydraulic excavator 100 also includes the abovementioned travel device 10, the rotation device 20, the drive member 34, the A/M switch 35, and the work implement 40.

The communication unit 61 is able to communicate with the communication unit 55 of the management server 52 in the management device 200 over the communication network.

The management controller 62 is connected to the communication unit 61, the monitor controller 63, and the drive controller 65. The management controller 62 includes a relay unit 71 and a storage unit 72.

The relay unit 71 relays communication between the monitor controller 63, the drive controller 65, and the management device 200.

The storage unit 72 stores data relating to the MC function. Specifically, the storage unit 72 stores the contract information. In the present embodiment, the storage unit 72 unitarily manages the data relating to the MC function. The storage unit 72 is configured by, for example, a non-volatile or volatile semiconductor memory or magnetic disc such as a read-only memory (ROM), a random access memory (RAM), a hard disk drive (HDD), or a flash memory.

The monitor controller 63 is connected to the management controller 62 and the monitor 64. The monitor controller 63 includes an acquisition unit 73 and a display unit 74.

The acquisition unit 73 requests the communication unit 55 of the management server 52 for the contract information via the management controller 62 and the communication unit 61 in order. While the timing of the request for the contract information by the acquisition unit 73 is not limited in particular, the request for the contract information is desirably issued at the engine activation of the hydraulic excavator 100. The acquisition unit 73 acquires the contract information from the communication unit 55 of the management server 52 via the communication unit 61 and the management controller 62 in order. The acquisition unit 73 stores the acquired contract information in the storage unit 72 of the management controller 62.

The display unit 74 displays various types of information on the monitor 64. The display unit 74 displays a pop-up message indicating to the user of the MC function that a charge will be incurred, and a confirmation button on the monitor 64 when a belowmentioned unlock notification is received from the drive controller 65. The display unit 74 erases the pop-up message when the confirmation button is pressed by the user.

The monitor 64 is a device for displaying various types of information such as images. For example, a touch panel provided with an operation function and a display function can be used as the monitor 64. The monitor 64 is, for example, a liquid crystal display panel or an organic electroluminescence (EL) panel.

The drive controller 65 is connected to the travel device 10, the rotation device 20, the drive member 34, the A/M switch 35, the work implement 40, and the management controller 62. The drive controller 65 includes a determining unit 75, a drive unit 76, and a measuring unit 77.

The determining unit 75 acquires the contract information stored in the storage unit 72 of the management controller 62. The determining unit 75 determines whether there is the right to use the MC function based on the contract information. Specifically, the determining unit 75 determines that there is the right to use the MC function when the usage pattern included in the contract information is the usage pattern A or the usage pattern B, and determines that there is not the right to use the MC function when the usage pattern included in the contract information is the usage pattern C. The fact that there is the right to use the MC function indicates that the user is able to use all of the MC functions provided to the work machine. The fact that there is not the right to use the MC function indicates that the user is not able to use any of the MC functions provided to the work machine.

When the determining unit 75 has determined that there is the right to use the MC function, the MC function is kept in standby in the locked state until an unlock operation is received by the A/M switch 35. When the determining unit 75 has determined that there is the right to use the MC function, the MC function is unlocked and the unlock notification is transmitted to the display unit 74 of the monitor controller 63 when the A/M switch 35 receives the unlock operation. The determining unit 75 locks the MC function when a lock operation is received by the A/M switch 35 after the MC function has been unlocked.

When the determining unit 75 has determined that there is not the right to use the MC function, that is, when the usage pattern included in the contract information is the usage pattern C, the MC function is kept locked regardless of whether an unlock operation is received by the A/M switch 35.

The MC function for automatically or semi-automatically controlling the operations of the drive mechanism (at least one of the travel device 10, the rotation device 20, and the work implement 40) is installed in the drive unit 76.

When the MC function is locked by the determining unit 75, the drive unit 76 drives the drive mechanism in accordance with the manual operations of the drive member 34 performed by the user. When the MC function is unlocked by the determining unit 75, the drive unit 76 drives the drive mechanism in accordance with only the MC function regardless of the manual operations performed by the user, or in accordance with the manual operations performed by the user that are corrected based on the MC function.

The measuring unit 77 measures the unlock time period of the MC function when the usage pattern included in the contract information is the usage pattern B. The unlock time period is a time period from when the determining unit 75 has unlocked the MC function until the MC function is locked. For example, the measuring unit 77 is able to derive the unlock time period or the number of days of unlocking by using an electronic device such as a timer IC to detect the start of measurement and the end of measurement of the unlock time period.

The measuring unit 77 transmits the measured unlock time period to the communication unit 55 of the management server 52 via the management controller 62 and the communication unit 61 in order. The measuring unit 77 may transmit the unlock time period to the communication unit 55 each time the unlock time period is measured, or may transmit the sum of the unlock time periods at a predetermined timing (for example, every 24 hours or when the engine is stopped) to the communication unit 55.

### (Control Method)

Hereinbelow, a control method of the control system 1 according to the present embodiment will be explained with reference to the drawings. Specifically, a control for determining whether or not there is the right to use the MC function and a control for calculating the charging amount for the use of the MC function will be explained.

### (MC Function Switching Control)

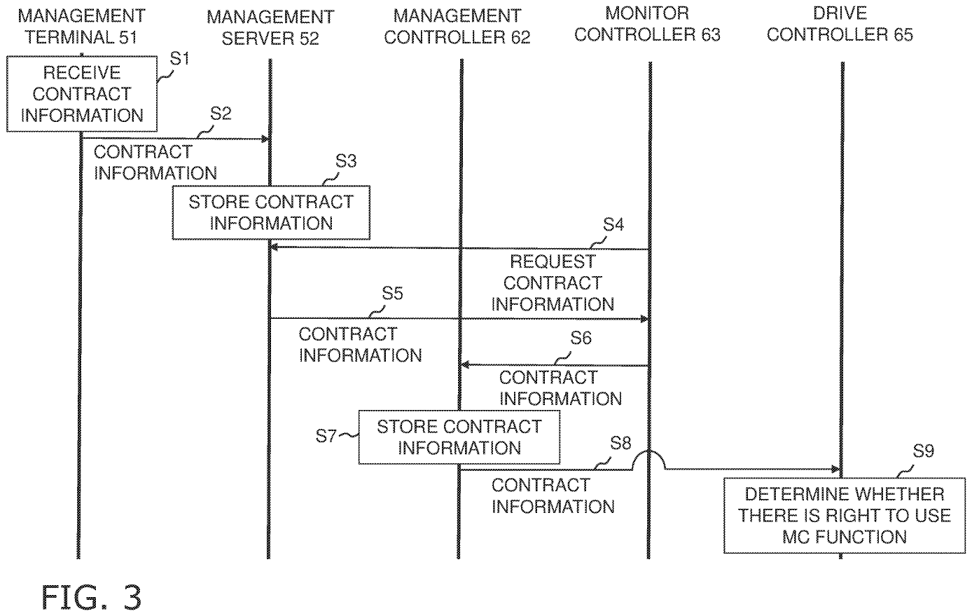

FIG. 3 is a flow chart for explaining the control for determining whether there is the right to use the MC function.

In step S1, the management terminal 51 receives the input of the contract information (including at least one of the usage pattern A, the usage pattern B, and the usage pattern C) relating to the use of the MC function.

In step S2, the management terminal 51 transmits the contract information to the management server 52.

In step S3, the management server 52 stores the received contract information.

In step S4, the monitor controller 63 issues a request for the contract information to the management server 52.

In step S5, the management server 52 transmits the contract information to the monitor controller 63.

In step S6, the monitor controller 63 transmits the contract information to the management controller 62.

In step S7, the management controller 62 stores the received contract information.

In step S8, the drive controller 65 acquires the contract information from the management controller 62.

In step S9, the drive controller 65 determines whether there is the right to use the MC function based on the contract information. The drive controller 65 determines that there is the right to use the MC function when the usage pattern included in the contract information is the usage pattern A or the usage pattern B, and determines that there is not the right to use the MC function when the usage pattern included in the contract information is the usage pattern C.

### (Charging Control)

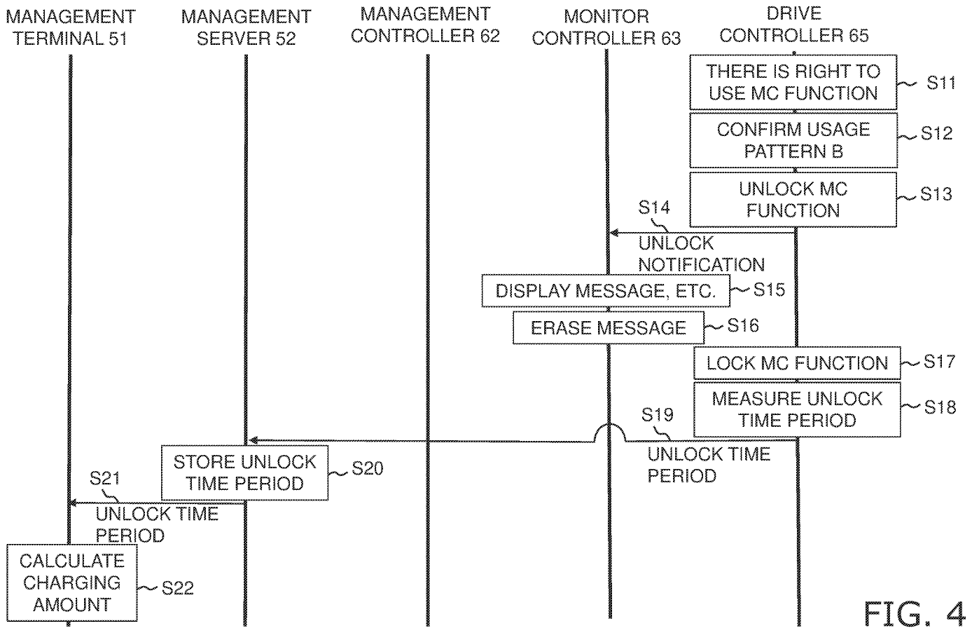

FIG. 4 is a flow chart for explaining a control for calculating a charging amount for the use of the MC function.

In step S11, the drive controller 65 determines that there is the right to use the MC function.

In step S12, the drive controller 65 confirms that the usage pattern included in the contract information is the usage pattern B. Because the usage fee for the MC function is included in the purchase price of the hydraulic excavator 100 in the usage pattern A, the charge control is not performed. Because the right to use the MC function is not determined in step S11 with the usage pattern C, the charge control is not performed. An explanation of a situation when the usage pattern is the usage pattern B will be explained herein.

In step S13, the drive controller 65 unlocks the MC function in accordance with the unlock operation being received by the A/M switch 35. As a result, the drive mechanism of the hydraulic excavator 100 enters a state of being controlled automatically or semi-automatically in accordance with the MC function.

In step S14, the drive controller 65 transmits the unlock notification to the monitor controller 63.

In step S15, the monitor controller 63 displays a pop-up message indicating to the user of the MC function that a charge will be incurred, and a confirmation button on the monitor 64.

In step S16, the monitor controller 63 erases the pop-up message when the confirmation button is pressed by the user.

In step S17, the drive controller 65 locks the MC function in accordance with the lock operation being received by the A/M switch 35. As a result, the drive mechanism of the hydraulic excavator 100 enters a state of not being controlled in accordance with the MC function.

In step S18, the drive controller 65 measures the unlock time period from when the MC function is unlocked until the MC function is locked.

In step S19, the drive controller 65 transmits the measured unlock time period to the management server 52.

In step S20, the management server 52 stores the received unlock time period.

In step S21, the management terminal 51 acquires the unlock time period stored by the management server 52.

In step S22, the management terminal 51 calculates the charging amount relating to the use of the MC function based on the acquired unlock time period.

### (Characteristics)

(1) The control system 1 comprises the drive controller 65 and the acquisition unit 73 of the monitor controller 63. The drive controller 65 controls the drive mechanism (at least one of the travel device 10, the rotation device 20, and the work implement 40). The acquisition unit 73 acquires contract information relating to the use of the MC function. The drive controller 65 determines, based on the contract information, whether or not the user has right to use the MC function of the drive mechanism.

In this way, the price of the hydraulic excavator 100 can be set in accordance with the usage pattern that indicates the usage form of the MC function because it is possible to determine whether there is right to use the MC function based on the contract information. Therefore, the hydraulic excavator 100 can be easily introduced into ICT construction because the initial investment cost for the user can be limited by selecting a usage pattern with which the price of the hydraulic excavator 100 is suppressed.

(2) The drive controller 65 determines that there is the right to use the MC function when the contract information indicates that there is a charge for using the MC function (that is, when the usage pattern included in the contract information is the usage pattern B). In this way, the development costs of the MC function can be recovered due to the determination that there is right to use the MC function even when there is a need to charge for the use of the MC function. Therefore, the price of the hydraulic excavator 100 can be suppressed because there is no need to incorporate the development costs of the MC function into the price of the hydraulic excavator 100. Additionally, the user who uses the work machine provided with the MC function is able to use the MC function by using a simple system.

(3) When the drive controller 65 has determined that there is the right to use the MC function, the MC function is unlocked when the A/M switch 35 receives the unlock operation. In this way, the unintentional execution of the MC function can be suppressed because the MC function is unlocked based on an operation by the user even when it is determined that there is the right to use the MC function.

(4) The drive controller 65 unlocks the MC function in accordance with the unlock operation being received by the A/M switch 35. In this way, the unintentional completion of the MC function can be suppressed because the MC function is unlocked based on an operation by the user.

(5) The control system 1 comprises the charging unit 54 of the management terminal 51. The charging unit 54 calculates the charging amount for the use of the MC function based on the unlock time period of the MC function. Therefore, a proper charging amount can be calculated in accordance with the usage status of the MC function.

### MODIFIED EXAMPLES OF THE EMBODIMENT

The present disclosure is not limited to the above embodiment and various changes are possible without departing from the scope of the present disclosure.

### Modified Example 1

The user may also be a person who rents or leases the hydraulic excavator 100. Such a user may be the person who actually operates the hydraulic excavator 100, the person who manages the rented or leased hydraulic excavator 100, or both. In this case, the person who operates the management terminal 51 is the rental agent or the leasing agent.

### Modified Example 2

While the hydraulic excavator 100 has been used as an example of the work machine in the above embodiment, the work machine is not limited to a hydraulic excavator. The work machine may be any machine with which the drive mechanism can be automatically controlled or semi-automatically controlled in accordance with an MC function. For example, in addition to a hydraulic excavator, a bulldozer, a dump truck, a wheel loader, or a motor grader could be used as examples of the work machine.

### Modified Example 3

While the management device 200 in the above embodiment manages only one work machine (the hydraulic excavator 100), the number of work machines is not limited in particular. When the management device 200 manages a plurality of work machines, the management device 200 is able to manage the contract information and the unlock time period in association with a unique ID of each work machine.

### Modified Example 4

While the A/M switch 35 has been explained as an example of an operating unit in the above embodiment, the operating unit is not limited to the A/M switch 35. The operating unit may be any device with which it is possible to receive a lock operation and an unlock operation for the MC function from the user. For example, the operating unit may be a lever or may be a virtual button displayed on the monitor 64.

### Modified Example 5

While the acquisition unit 73 is included in the monitor controller 63 in the above embodiment, the acquisition unit 73 may also be included in the management controller 62 or the drive controller 65.

### Modified Example 6

While the charging unit 54 is included in the management terminal 51 of the management device 200 in the above embodiment, the charging unit 54 may also be included in the management server 52 of the management device 200, or the management controller 62, the monitor controller 63, or the drive controller 65 of the hydraulic excavator 100.

### Modified Example 7

While one pattern is included in the contract information and the drive controller 65 collectively determines whether there is the right to use the MC function that can be implemented in the hydraulic excavator 100, the above embodiment is not limited in this way.

The contract information may include one or more types of automatic control functions set as having the right to use and may include a usage pattern set for each type of automatic control function. In this case, the drive controller 65 determines whether there is the right to use for each one of the automatic control functions based on the contract information. For example, if the usage pattern A is set for the automatic work implement stop control function and the usage pattern B is set for the automatic leveling assist control function in the contract information, the drive controller 65 determines that there is the right to use the automatic work implement stop control function and the automatic leveling assist control function as the automatic control functions. The A/M switch 35 receives a lock operation and an unlock operation for each automatic control function from the user. The determining unit 75 of the drive controller 65 unlocks the predetermined function for which the A/M switch 35 received the unlock function among the automatic control functions determined as having the right to use. Thereafter, when the A/M switch 35 receives the lock operation for the predetermined function, the determining unit 75 of the drive controller 65 locks the predetermined function.

The measuring unit 77 measures the unlock time period for the automatic leveling assist control function set to the usage pattern B. The charging unit 54 calculates the charging amount for the use of the automatic leveling assist control function based on the unlock time period of the automatic leveling assist control function.

When the contract information includes one or more types of automatic control functions set as having the right to use and includes a usage pattern set for each type of automatic control function, the reception unit 53 may receive a plurality of pieces of contract information. In this case, the drive controller 65 determines whether there is the right to use each one of the automatic control functions described in each piece of contract information.

### Modified Example 8

While the A/M switch 35 that is an example of the operating unit is described as being mounted to the work machine in the above embodiment, the present invention is not limited in this way. The functions of the A/M switch 35 may be built into a mobile terminal owned by the user who is the administrator of the work machine. In this case, a predetermined signal is transmitted to the drive controller 65 due to the administrator operating the mobile terminal and the drive controller 65 may determine there is the right to use the MC function and unlock or lock the MC function. When the functions of the A/M switch 35 are built into a mobile terminal, the mobile terminal serves as an example of the “operating unit” according to the present disclosure.

### Modified Example 9

While the monitor controller 63 acquires the contract information stored in the storage unit 56 of the management server 52 and then stores the acquired contract information in the storage unit 72 of the management controller 62 in the above embodiment, the method for storing the contract information in the storage unit 72 is not limited in this way.

If the monitor controller 63 is not able to acquire the contract information from the management server 52, the contract information may be stored in the storage unit 72 of the management controller 62 without going through the management server 52.

If the monitor controller 63 is not able to acquire the contract information from the management server 52, for example, the following situations my be possible: (a) the contract information has not been stored yet in the storage unit 56 of the management server (specifically, in the case of a specification inspection before shipping of the hydraulic excavator 100, etc.); (b) the management server 52 and the hydraulic excavator 100 are not able to establish communication (specifically, when the hydraulic excavator 100 is being used in a location where there is no communication environment, for example); and (c) when the user does not have right to use the management server 52 (for example, when the user has not finalized the user contract with the management server 52 from the beginning, etc.).

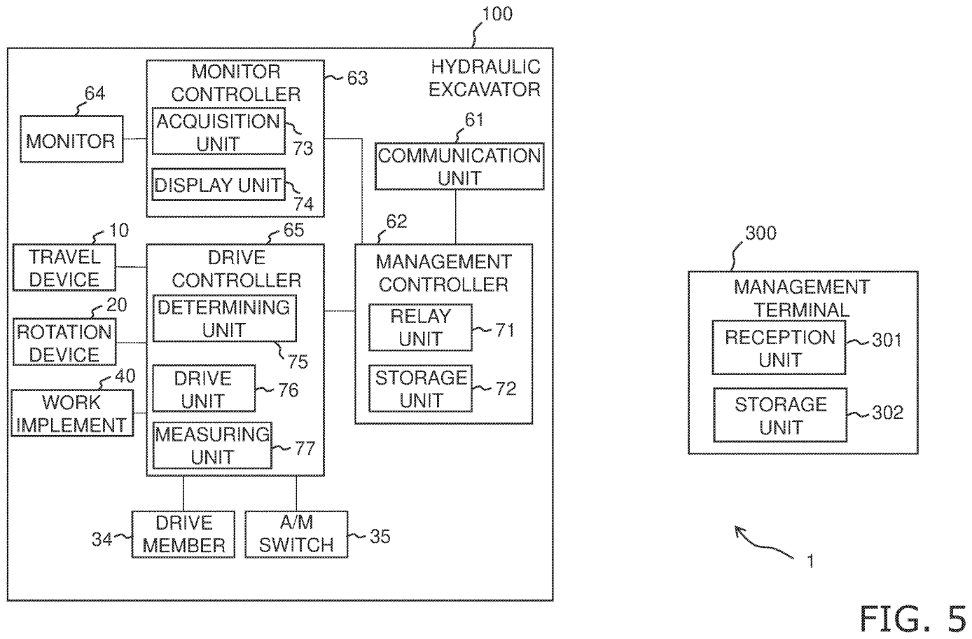

An example using a mobile terminal 300, as illustrated in FIG. 5, is raised as a method for storing the contract information in the storage unit 72 of the management controller 62 without going through the management server 52.

The mobile terminal 300 is used by the user of the 100. The mobile terminal 300 is able to communicate by wire or wirelessly with the hydraulic excavator 100. The mobile terminal 300 comprises a reception unit 301 and a storage unit 302.

The reception unit 301 receives the input of the contract information relating to the use of the MC function from the user. The storage unit 302 stores an application for storing the contract information in the storage unit 72 of the management controller 62.

A control for storing the contract information in the storage unit 72 of the management controller 62 will be explained. First, the management controller 62 is activated. The activation of the management controller 62 is performed by turning on the ignition of the hydraulic excavator 100 or by directly activating the management controller 62. Next, the contract information is stored in the storage unit 72 of the management controller 62 due to the reception unit 301 executing the application stored in the storage unit 302. The reception unit 301 executes the application in accordance with the reception unit 301 receiving an input of an execution command from the user, or in accordance with a request from the activated management controller 62. Next, after the communication between the reception unit 301 and the management controller 62 is finished, the management controller 62 is turned off.

In the case of (a) and (b) above, the contract information stored in the storage unit 72 of the management controller 62 may be stored (or rewritten) in the storage unit 56 of the management server 52 or the contract information stored in the storage unit 56 of the management server 52 may be stored (or rewritten) in the storage unit 72 of the management controller 62, after the communication between the hydraulic excavator 100 and the management server 52 has been established. Alternatively, when the contract information stored in the storage unit 72 of the management controller 62 is different from the contract information stored in the storage unit 56 of the management server 52, the fact that the pieces of contract information are different may be notified to the management terminal 51 without rewriting the contract information.

A control for switching the MC function in the hydraulic excavator 100 will be explained. In the present modified example, the contract information is previously stored in the storage unit 72 of the management controller 62 and, therefore, steps S1 to S7 illustrated in FIG. 3 are substantially omitted. Specifically, first the hydraulic excavator 100 is activated whereby the management controller 62 is activated. Next, the drive controller 65 acquires the contract information from the management controller 62. Next, the drive controller 65 determines, based on the contract information, whether or not a user has the right to use the MC function. The drive controller 65 determines that there is the right to use the MC function when the usage pattern included in the contract information is the usage pattern A or the usage pattern B, and determines that there is no right to use the MC function when the usage pattern included in the contract information is the usage pattern C in the same way as the above embodiment.

A control for calculating the charging amount for the use of the MC function will be explained. First, when the drive controller 65 determines that there is the right to use the MC function, the drive controller 65 confirms that the usage pattern included in the contract information is the usage pattern B. The charging control is not executed for the usage pattern A or the usage pattern C in the same way as the above embodiment. Next, the drive controller 65 measures the unlock time period from when the MC function is unlocked until the MC function is locked. Next, the charging amount is calculated as indicated below based on the unlock time period. In the case of (a) above, the charging amount is not generated because the MC function is not used in the actual work. In the case of (b) above, the charging amount is calculated by the management terminal 51 as described above when communication between the hydraulic excavator 100 and the management server 52 is established. In the case of (c) above, the drive controller 65 calculates the charging amount due to the drive controller 65 having the function of the charging unit 54. In this case, the drive controller 65 may store the payment amount previously paid by the user for the use of the MC function, and may unlock the MC function until the charging amount reaches the payment amount and may lock the MC function at the time that the charging amount reaches the payment amount.

### (Appendix 1)

A control system that determines whether there is a right to use a machine control function of a drive mechanism provided to a work machine, the control system comprising a drive controller that controls the drive mechanism and an acquisition unit that acquires contract information relating to the use of the machine control function, the drive controller determining whether there is the right to use based on the contract information.

### (Appendix 2)

The control system described in appendix 1 wherein the drive controller is configured to determine that there is the right to use when the contract information indicates that there is a need to charge for the use of the machine control function.

### (Appendix 3)

The control system described in appendix 2 further comprising an operating unit that is configured to receive a lock operation and an unlock operation of the machine control function, wherein the drive controller unlocks the machine control function when the operating unit received the unlock operation in a case where it has been determined that there is the right to use.

### (Appendix 4)

The control system described in appendix 3 wherein the drive controller is configured to lock the machine control function when the operating unit received the lock operation.

### (Appendix 5)

The control system described in appendix 4 further comprising a charging unit configured to calculate a charging amount for the use of the machine control function based on an unlock time period of the machine control function.

### (Appendix 6)

The control system described in appendix 2 wherein the machine control function includes a plurality of automatic control functions, the system further comprises an operating unit that receives a lock operation and an unlock operation for each of the plurality of automatic control functions, and the drive controller unlocks the predetermined function among the plurality of automatic control functions when the operating unit receives the unlock operation for the predetermined function when it has been determined that there is the right to use.

### (Appendix 7)

The control system described in appendix 6 wherein the drive controller locks the predetermined function when the operating unit receives the lock operation for the predetermined function.

### (Appendix 8)

The control system described in appendix 7 further comprising a charging unit that calculates a charging amount for the use of the predetermined function based on the unlock time period of the predetermined function.

### (Appendix 9)

The control system described in any one of appendices 1 to 8, wherein the contract information includes at least a usage pattern that requires charging for the use of the machine control function and a usage pattern that does not require charging for the use of the machine control function as usage patterns that indicate a usage form for the machine control function.

### (Appendix 10)

A control method comprising a step for acquiring contract information relating to an use of a machine control function of a drive mechanism provided in a work machine, and a step for determining whether there is a right to use the machine control function based on the contract information.

1. A control system that determines whether there is a right to use a machine control function of a drive mechanism provided in a work machine, the control system comprising:
a drive controller configured to control the drive mechanism; and
an acquisition unit configured to acquire contract information relating to the use of the machine control function,
the drive controller being configured to determine whether there is the right to use the machine control function based on the contract information.

2. The control system according to claim 1, wherein
the drive controller is configured to determine that there is the right to use the machine control function when the contract information indicates that there is a need to charge for the use of the machine control function.

3. The control system according to claim 2, further comprising:
an operating unit configured to receive a lock operation and an unlock operation of the machine control function,
the drive controller being configured to unlock the machine control function when the operating unit received the unlock operation in a case in which it has been determined that there is the right to use the machine control function.

4. The control system according to claim 3, wherein
the drive controller is configured to lock the machine control function when the operating unit received the lock operation.

5. The control system according to claim 4, further comprising:
a charging unit configured to calculate a charging amount for the use of the machine control function based on an unlock time period of the machine control function.

6. The control system according to claim 1, wherein
the machine control function includes one or more automatic control functions, and
the drive controller is configured to determine whether there is the right to use each of the one or more automatic control functions based on the contract information.

7. The control system according to claim 6, further comprising:
an operating unit configured to receive a lock operation and an unlock operation of the one or more automatic control functions,
the drive controller being configured to unlock a predetermined function when the operating unit received the unlock operation for the automatic control function for which it has been determined that there is the right to use the machine control function.

8. The control system according to claim 7, wherein
the drive controller is configured to lock the predetermined function when the operating unit received the lock operation for the predetermined function.

9. The control system according to claim 8, further comprising:
a charging unit configured to calculate a charging amount for the use of the predetermined function based on the unlock time period of the predetermined function.

10. The control system according to claim 1, wherein
the contract information includes at least one of
a usage pattern that requires charging for the use of the machine control function and
a usage pattern that does not require charging for the use of the machine control function that indicate a usage form for the machine control function.

11. A control method comprising:
acquiring contract information relating to a use of a machine control function of a drive mechanism provided in a work machine; and
determining whether there is a right to use the machine control function based on the contract information.
